(19) United States
(12) Patent Application Publication
(10) Pub. No.: US 2004/0055474 A1
(43) Pub. Date: Mar. 25, 2004

(54) Multifunctional combined apparatus for food preparation

(76) Inventors: Mirjana Lekic, Maribor (SI); Alexander Cavallieri, Maribor (SI)

Correspondence Address: CONNOLLY BOVE LODGE & HUTZ LLP, SUITE 800, 1990 M STREET NW, WASHINGTON, DC, 20036-3425, US

(21) Appl. No.: 10/251,838

(22) Filed: Sep. 23, 2002

(51) Int. Cl. A23L 1/00; A47J 37/12

(52) U.S. Cl. 99/330; 99/403

(57) ABSTRACT

The multifunctional combined apparatus for food preparation is a professional catering or household device for thermal food preparation. This device enables a multipurpose food preparation. The essence of the construction of the new device is introduction of a rotary drum (1) in the interior of the oven. Onto inner surfaces of the rotating drum (1) are attached or shaped out of the drum attachments or shovels (4) which are meant to distribute liquids. In the centre of the drum we can statically place baskets or static sheet metal containers (6). Into the drum (1) we can also place divided chambers (7) for food. Once attached, they rotate together and in the same direction with the drum. The second possibility of the construction is that device is based upon the static drum, where the axis is arranged horizontally and into which are placed rotary attachments meant to attach rotary consoles. In the first option of the second possibility of construction, shovels (9) meant for spilling liquids over the food are attached onto the rotary consoles. In the second option of the second possibility of construction, one or more wire-netted or perforated chambers (10) for food are placed or attached onto the rotary consoles.

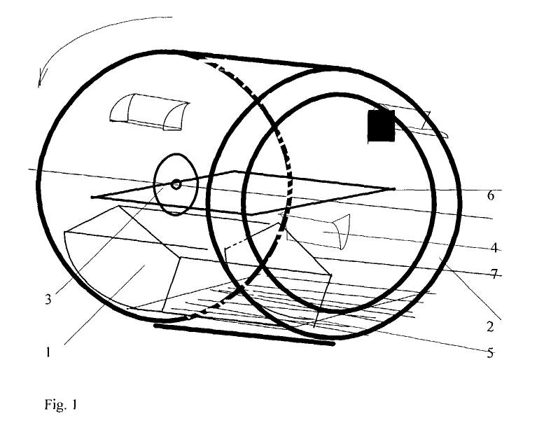

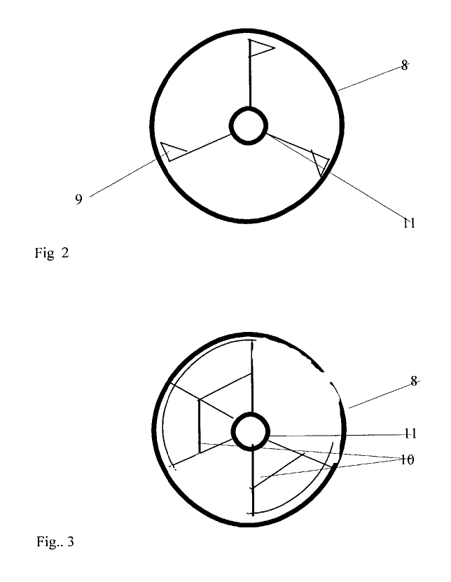

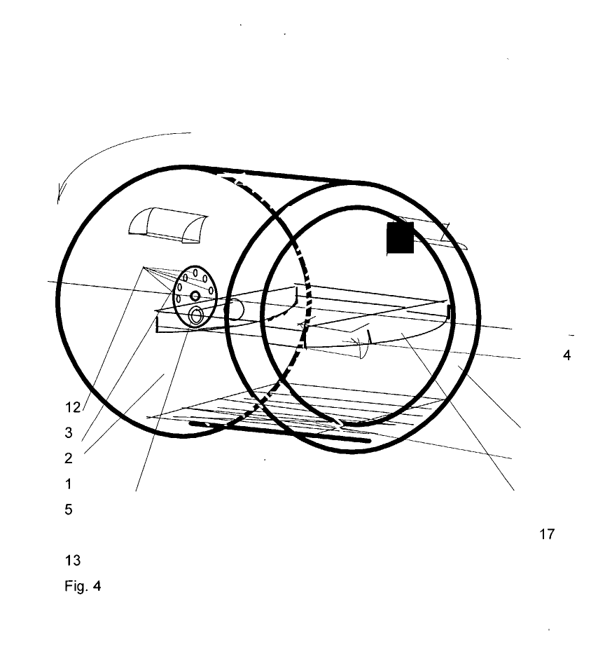

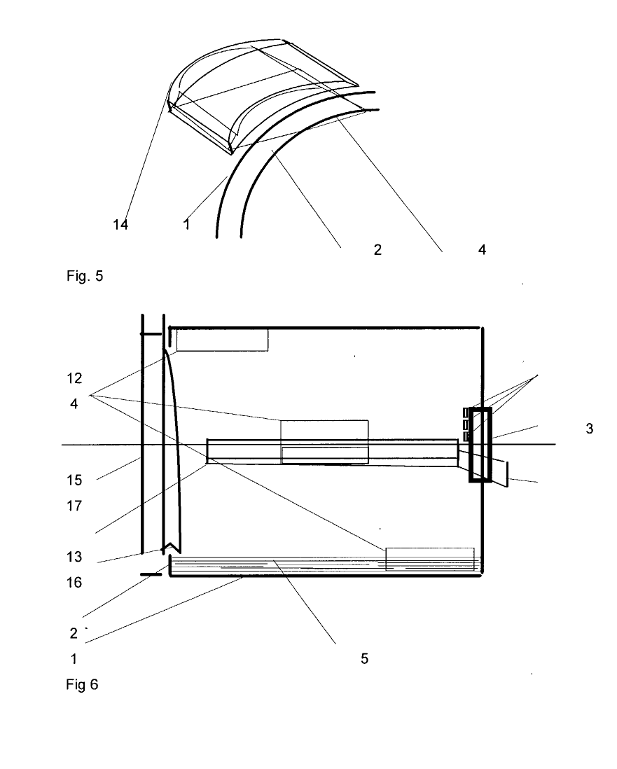

### FIELD OF THE INVENTION

The invented item is a household or professional apparatus, which enables many possible ways of thermal food preparation. Technical problem solved by this invention is such an apparatus construction which enables multipurpose preparation of food: deep frying, baking, roasting, grilling by using a minimal amount of oil or by using no oil and also steam-cooking.

### BACKGROUND OF THE INVENTION

Until now these options of thermal food preparation there were available: deep fryers for frying in the deep oil, various ovens for baking, stewing or grilling and steam-cookers for cooking in steam.

The construction of the new apparatus enables and merges all above mentioned possibilities for thermal food preparation. At the same time it solves some of the specific problems that occur at thermal food preparation by devices, known until now. The problem of roasting in the oven is that food, for instance meat, has to be turned and oiled from time to time. The problem of frying in deep fryers is extensive usage of edible oil and consequential ecological problem of waist oils. That is very important issue in catering industry. Big oil consumption also causes high costs of food preparation, so people use the same oil many times and such as oil is a possible cause for cancer development. This problem is also present at the food preparation in households.

At deep frying we also noticed the problem of extensive oil absorption into the food, as thermal preparation often softens the food that becomes more porous. Foods prepared as that are bigger health risk and more caloric. The problem of steam-cookers is that their usage is limited only to a single function, so despite that this kind of food preparation is among the healthiest, they did not reach the level of massive usage in households. So, people rather cook in pots with added water. This manner causes loss of vitamins and minerals, unequal cooking, overcooking or burning the foods.

### STATE OF THE ART

European Patent Application No. 0 140 237 A describes a rotary device, with central shaft, with centrically positioned front and back annular plate. Multiple rectangular vessels, which serve as food compartments, are attached between these annular plates and around the shaft. These vessels are covered with perforated or meshy cover, which prevent the food to fall out of the vessels and enable the steam or liquid to penetrate in or our of the vessel. This completed device, when food compartments are filled with food is put into a rectangular oven and, rotates around its horizontal axis. Problem of this solution is that this device was constructed to function as an indoor barbeque with rotary grill only. This construction allows the excessive oil, which comes out of foods during the thermal process, to drain out of the vessel but this device does not enable other functions like deep-frying, so it does not cover the area of lower oil consumption solutions at all.

### SUMMARY OF THE INVENTION

The essence of the new apparatus construction (DRAFT 1) is the application of a rotating drum (1) inside the oven. The axis of the swiveling drum is horizontally arranged. Shovels, sometimes also called ladles (4) are fixed in the inner surfaces and on the different positions of the drum. Their purpose is to ladle out and spill liquids, sauces, oil, etc., over the food. The frontal frame (2) of the drum is high enough to prevent the discharge of the liquids (5). The housing of the device and the arrangement of the opening can be manufactured in many ways. The shovels are attached onto different but determined places around the drum, so that a harmonious oil or liquid distribution onto foods is possible. The first function of the swiveling drum is defined by carrying the edible oil from the bottom of the drum to the upper position. This enables the gradual spilling over the food, positioned onto or into the static sheet metal containers (6) within the drum. In the central position of the swiveling drum can be statically attached static sheet metal containers (6), which are meant for different purposes of food preparation. These static sheet metal containers can be perforated or wire-netted or made of a wavy metal sheet material. Different shapes of these static sheet metal containers enable different levels of oil draining and also an equal steam distribution. The second function of the rotary drum is the possibility of using the other type of sheet metal containers or so called chambers (with perforation or wire-netting), which we can attach to the drum. These chambers for food (7) can be attached onto the drum as a single chamber or connected together as multiple chambers. Once attached, they rotate together with the drum and also in the same direction. This kind of frying enables the food to be dipped into the oil (5) every time when the food is going through the bottom position. The food and oil contact are short and only at the food surface, so after the upward motion and during every circulation, oil flows away. The oil absorption into the food is decreased also. One or more connected chambers (7) enable us to prepare one or more different sorts of foods at the same time. This type of the construction enables the food to be fixed in the chamber, so it can not slip around—it also protects the foods from smashing and damaging. The third function of the rotary drum exists in an even supply of heat, since the drum takes up the heat evenly during the rotation.

The source of heat is outside the drum and within the housing. If we switch-off the rotation of the drum and if we use water instead of oil, the device is ready for steam-cooking. Water from the bottom of the drum evaporates up to the food. It is also possible to remove the drum completely for cleaning.

The swiveling drum for thermal food preparation has already been used in the past, but that drum did not have the same purpose as the new device. The reason is that it only tumbled the food at its bottom. The drum has never been used to pour liquids over the food with shovels. It also never rotated the food, fixed in the chambers around the axis of the drum. Before mentioned solutions had some disadvantages, as the food was damaged and smashed during the tumbling. At the same time food absorbed too much oil, because it was constantly positioned at the bottom of the drum. The new multifunctional combined apparatus for food preparation unites many essential novelties and advantages. First innovation is the possibility of multipurpose usage of new device as we can use it to bake, deep-fry, roast stew, and to cook in steam. The second innovation is that the new device has shovels attached onto the drum to periodically pour liquids over the food, which is positioned onto static sheet metal containers. The third innovation is chambers for food which rotate together with the drum and are dipped into the oil at the bottom of the drum when it reaches the bottom position. The second and the third innovation by their function and effect can be described as an superior alternative—compared to usage of conventional deep-fryer or conventional oven, as it prevents foods of being constantly dipped into the oil. At the same time it also enables the food to be in the periodical contact with the oil, since the oil is distributed over the food with shovels. The fourth innovation is an even supply of heat because of the rotation of the drum. First essential advantage of the new multifunctional combined apparatus for food preparation is the possibility of the minimal usage of edible oil for frying. Compared to conventional deep-fryers where they managed to reduce usage of oil for 25% by declining the oil container. A new device can reduce usage of oil for at least 80%. So, usage of the new device can significantly decrease costs of food preparation, since the oil can be changed regularly. In this way a new device also contributes solving ecological problems. The second advantage is that foods are never in direct contact with the source of heat, since the food rotates, or is positioned in the centre of the drum onto the static sheet metal containers and cannot be burned.

Third advantage is that the new device has an even distribution of heat and can also be used for defrosting of various frozen foods by setting the appropriate temperature and without adding any liquids in to the drum. Fourth advantage is a possibility of making a device in different dimensions or for usage in professional catering industry. The second possibility of construction of this device (DRAFTS 2, 3) is usage of the static container for oil or liquids (8), shaped as cylinder, preferably as the lower half of the cylinder, where the axis is also horizontal. Rotary attachments (11) are installed into the central position of the drum (8).

Rotary consoles (9) or (10) can be fastened on rotary attachments. With the first version (Var.1.) of the second option of the construction (DRAFT 2), console with shovels or ladles (9) is attached onto the rotary attachment or shaft (11). Rotary consoles with shovels are meant to spill liquid onto the foods. With the second version Var. 2 of the second option of the construction (DRAFT 3), one or more perforated or wire-netting rotary consoles or meshy baskets (10) are attached onto the shaft (11), whereby at each rotation the food dips into the liquid.

Prior fryers have containers for oil, of cylindrical shape with vertical axis. In such container height of the oil multiplied by its horizontal area of the container provides oil capacity, as well as capacity of food to be fried in the oil. Accordingly fryers with oil capacity up to three liters are quite common for domestic use. In our effort to reduce the required oil volume and oil consumption we focused on the height of the oil, required for normal frying (the dipping height).

In the second version Var.2 (DRAFT 3) of the second embodiment of construction of the new apparatus, the dipping height is greatest in the middle of the container, which is shaped as a lower part of the drum with horizontal axis. Therefore the required oil volume is significantly lower compared to prior fryers, since oil container of the new apparatus has concave shape. Accordingly the new apparatus provides practically the same oil height, while the oil volume is smaller. Despite that, in second embodiment of the new fryer, the food capacity is double compared to what provide prior fryers. Namely in the new construction we use one or more above mentioned perforated or wire-netted food compartments, which are positioned on a rotating shaft, arranged horizontally in the axis of the above mentioned container. Multiple compartments may form a multi part food vessel, which may be taken to pieces, where each piece represents a single compartment. Such multi part food vessel has a shape of a whole cylinder with horizontal axis, as well as a volume of such whole cylinder. Accordingly the working volume of such multi part food vessel is twice bigger than the volume of the oil container.

Perforated compartments with food rotate attached to the rotating shaft in such a manner, that each compartment completely immerges into the oil bath. Immerging compartment with food displaces the oil and thus raises the oil level in the oil container. Accordingly the actual dipping height of is significantly lower compared to the height of the oil when compartments with food are immerged into the oil. And lower oil level reduces the required oil volume, and thus required quantity of the oil.

If we compare the second embodiment of the apparatus with prior constructions, it becomes obvious that the new construction effectively solves the problem of to big oil consumption. Use of a container, shaped as a lower part of the drum with horizontal axis in combination with perforated or wire-netted food compartments attached onto a rotating shaft reduces volume of oil required for frying up to 80%, and at the same time increases the capacity of treated food for up to 100%.

In both drum options—rotating or static drum, one or more openings or pouts (12) can be arranged onto the static attachment (3) to spout out water or oil over the foods, positioned onto the static sheet metal containers (6). Said static attachment (3) is positioned in the centre of the back-side of the rotating drum (1), and does not rotate with the rotating drum (1).

In case of spouting out the oil, in the housing of the device is also placed an oil container. This oil is pressured through pouts (12) over foods. Water pouts can be connected either to the water tap or to the water container which enables spouting out water under the pressure. Primary function of spouting out water is to add water for cleaning and rinsing at the self cleaning system. The water outflow can be constructed in two modes. In the first mode we fasten the fluid collector (13) into the static attachment (3). Shovels (4) ladle out the water from the bottom of the drum. Once brought in upper position, the water is spilled into the fluid's collector (13). Afterwards we take the fluid's collector out of the drum and empty it manually. At the second mode of the water outflow, the water, collected in the fluid's collector, drains through the static attachment (3) into the opening (17), made for draining. The second mode of cleaning, combined with the appropriate temperature and cleanser, enables the device to run fully automated self-cleaning system. Fluid's collector (13) can also be used for collecting fluids by defrosting foods.

In the device's housing is placed the electronic regulator, which has different programs that manage speed of rotating drum, temperature, switch on and off the rotation of the drum, self-cleaning function etc. Electronic regulator is programmed to warm up oil before it starts the rotation of the drum, so that sensitive raw foods, as fried meats in bread-crumbs are prevented from damaging. After the thermal food preparation, the electronic regulator is also programmed to stop the rotating drum in such a position, that compartments with food (7) or (10) are not dipped into oil and can be poured off. At the position that is covered with the shovel (4), the wall of the rotating drum is shaped to increase the collection of the oil or fluids. The wall forms a kind of channel (14). This channel enables attaching the shovels onto the wall of the rotating drum and also allows the shovel to increase its volume. It also directs the oil into the shovels. This solution is very practicable when we use minimal amounts of oil or other fluids. The doors (door?) (15) are (is) designed to prevent oil or fluids from leaking out of the drum and (is) are also designed to return the fluids into the drum.

The doors are convexly shaped. This convection increases to the lowest point of the door. At the lowest part of the door is formed the channel that enables oil to return into the drum. Different designs of the device's housing make possible combinations of this device with other, already known devices for food preparation. In this way we can install electric or gas cooking plates, grilling plates or ceramic cooking plates. Into the housing of device we can also install conventional electrical or gas oven. Inside the new apparatus we can install microwave sources. Into the housing of the device we can also install the compressor that creates vacuum, meant for vacuum thermal food preparation.

1. Multifunctional combined apparatus for food preparation such as deep frying and steam cooking, consisting of a housing and, inside the said housing, a static drum, in which a volume for oil, water or other liquid is provided, where a means with at least one chamber for food is rotated or swung by the an actuator around the horizontal axis and is heated by a heater placed inside or outside the said static drum, characterized in that in the lower part of the static drum a volume for oil, water or another liquid is provided into which at least one rotating chamber for the food is immersed for approximately a quarter of the radius of the chamber rotation, whereat in said chambers the oil, water or other liquid located in the lower part of the static drum, or steam can enter and exit and whereat the volume of each chamber is relatively equal to or smaller than the volume of one average portion of food and that the total volume for the food of all chambers together is larger than the volume for oil in the static drum, preferably 2 to 4 times larger.

2. Multifunctional combined apparatus for food preparation according to claim 1, characterized in that under the horizontal axis of chamber rotation the volume for liquids in the static drum has the shape of a half cylinder, whereat the axis of the static drum and the axis of the chamber rotation are coaxial.

3. Multifunctional combined apparatus for food preparation according to claims 1 to 2, characterized in that at each rotation of the chambers with food the time ratio of food passing through the oil or other liquid and of food passing outside the oil or other liquid is approximately 1 to 2-4.

4. Multifunctional combined apparatus for food preparation according to claims 1 to 3, characterized in that the rotating or the swinging of the means with chambers is controlled by any device depending on the type of food preparation and the kind of food.

5. Multifunctional combined apparatus for food preparation according to claims 1 to 4, characterized in that as the heater there can be used an electric heater, a gas heater or a microwave source.

6. Multifunctional combined apparatus for food preparation according to claims 1 to 5, characterized in that for different kinds of food preparation a compressor is provided to change the pressure in the apparatus.
